(19) United States
(12) Patent Application Publication
(10) Pub. No.: US 2004/0017606 A1
(43) Pub. Date: Jan. 29, 2004

(54) Compound eyed optical system

(76) Inventors: Jen-Hu Wang, Kaohsiung Hsien (TW); Thomas C.K. Yang, Taipei (TW); An-Hwa Chang, Taipei (TW); Chi-Hang Wu, Shinju City (TW); Tsu-Hwang Chuang, Taipei (TW); Chung-Ming Chang, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/206,513

(22) Filed: Jul. 26, 2002

(51) Int. Cl. G02B 17/00

(52) U.S. Cl. 359/366; 359/364; 359/727; 359/859

(57) ABSTRACT

An optical system has a correction half-sphere lens having multiple secondary mirrors mounted on an outer periphery of the correction half-sphere lens. A primary half-sphere mirror is coaxial and shares a same curvature center with the correction half-sphere lens. The primary half-sphere mirror has multiple through holes each corresponding to one of the secondary mirrors and having a second correction lens received therein to receive light from the corresponding secondary mirror. A cap is provided on top of the primary half-sphere mirror and has a shutter in a center of the cap to control incident light coming to the system.

### BACKGROUND OF THE INVENTION

1. Field of the Invention

The present invention relates to an optical system, and more particularly to an optical system provided with a compound eyed mechanism so as to compensate for image distortion and color aberration.

2. Description of Related Art

In order to compensate the distance shortcoming of human eye sight, telescopes are invented to see objects far away. The principle of a telescope is to combine magnification and focusing these two different techniques to improve resolution. When employing an optical principle on the telescope, there is one thing, dispersion, which is a result of compromise between clearness and spherical aberration. Because of refraction, it is almost impossible to eliminate dispersion. To solve the problem, Isaac Newton invented a parabolic mirror for eliminating dispersion in telescopes. However, parabolic mirror is difficult to make and spherical aberrations still easily occur. Therefore, Soviet scientist Mr. Maksukov invented the Maksukov telescope and later he combined the Casegrain type telescope to form the Maksukov Casegrain telescope, as shown in FIG. 1. The telescope shown in FIG. 1 includes a spherical surface primary mirror (1), a correction lens (3) and a hyperbolic surface secondary mirror (5). Since both the primary mirror (1) and the correction lens (3) have spherical surface, they can be adjusted in focus and they are not concentric in general. But they can be also designed to share the same curvature center. The use of correction lens (3) is able to reduce the spherical dispersion of the primary mirror (1) to a minimum. The secondary mirror (5) reflects the light beam to form an image at a point (9) outside the primary mirror (1). A second correction lens (11) is employed in front of the primary mirror (1) to clear the image. The main advantage of the Maksukov Casegrain telescope is that the length is short and thus is easy to be transported. However, to have high magnification power, a large caliber lens is required so as to achieve the required resolution and thus the view is limited due to the larger caliber. On the contrary, if a wide range view such as wide angle, super wide angle and fish eye angle is required, the objects are close together, the peripheral image is distorted and thus resolution is worse if magnification is needed.

To overcome the shortcomings, the present invention tends to provide an improved optical system to mitigate and obviate the aforementioned problems.

### SUMMARY OF THE INVENTION

The primary objective of the present invention is to provide an improved optical system having a primary half-sphere mirror and a correction half-sphere lens coaxial with the primary half-sphere mirror. The correction half-sphere lens has multiple hyperboloidal secondary mirrors and the primary half-sphere mirror has multiple through holes each corresponding to one of the mirrors and having a second correction lens received therein to receive the light from the corresponding secondary mirror. With such an arrangement, multiple Maksukov Casegrain telescopes are integrated into one optical system so that a clear image with high resolution in wide range is obtained.

Another objective of the present invention is to provide a scanning device incorporated with the optical system so as to effectively form the observed image.

In order to accomplish the foregoing objective, the optical system of the present invention has a primary half-sphere mirror and a correction half-sphere lens coaxial and sharing a same curvature center with the primary half-sphere mirror. A cap is provided on top of the primary half-sphere mirror and has a shutter in a center of the cap and having the same working principle as a normal camera to control the incident light to the system of the present invention. The correction half-sphere lens has multiple secondary mirrors and the primary half-sphere mirror has multiple through holes each corresponding to one of the secondary correction lenses and having a second correction lens received therein to receive the light from the corresponding secondary mirror. With such an arrangement, multiple Maksukov Casegrain telescopes are integrated into one optical system so that a clear image with high resolution in wide range is obtained.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the conventional structure of a Maksukov Casegrain telescope;

FIG. 2 is a schematic view showing the optical system of the present invention;

FIG. 3 is a schematic view showing the principle of the optical system of the present invention;

FIG. 4 is a schematic view showing a scanned pattern of the optical system;

FIGS. 5 and 6 are perspective views of two different supporting devices incorporated with the optical system to achieve the same purpose; and

FIG. 7 is a schematic view showing a rotating track of the preferred embodiment shown in FIG. 6.

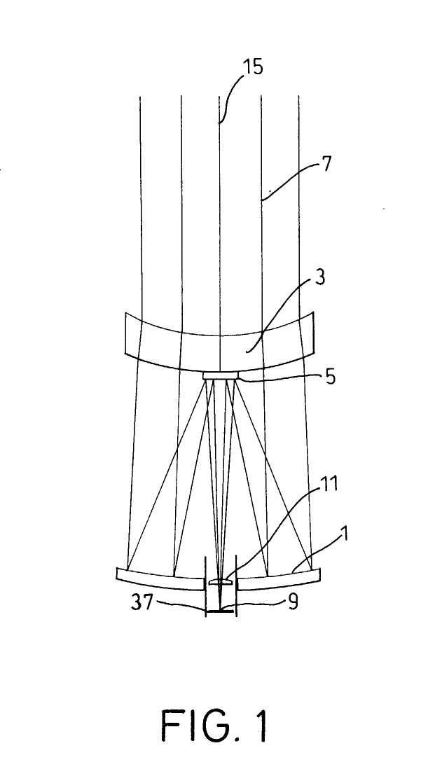

### DETAILED DESCRIPTION OF THE PREFERRED EMBODIMENT

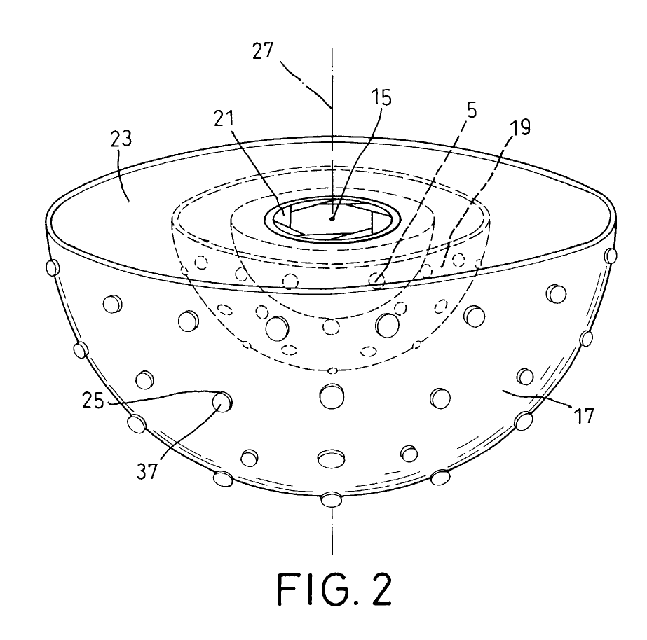

With reference to FIG. 2, the optical system in accordance with the present invention has a primary half-sphere mirror (17) and a correction half-sphere lens (19) coaxial and sharing a same curvature center (15) with the primary half-sphere mirror (17). Therefore, any incident light passing through the curvature center (15) has the same situations in nature. A cap (23) is provided on top of the primary half-sphere mirror (17) and has a shutter (21) in a center of the cap (23) and having the same working principle as a normal camera to control the incident light to the system of the present invention. The correction half-sphere lens (19) has multiple secondary mirrors (5) and the primary half-sphere mirror (17) has multiple through holes (25) each corresponding to one of the secondary mirrors (5) and having a second correction lens (11) received therein to receive the light from the corresponding secondary mirror (5). With such an arrangement, multiple Maksukov Casegrain telescopes are integrated into one optical system so that a clear image with high resolution in wide range is obtained.

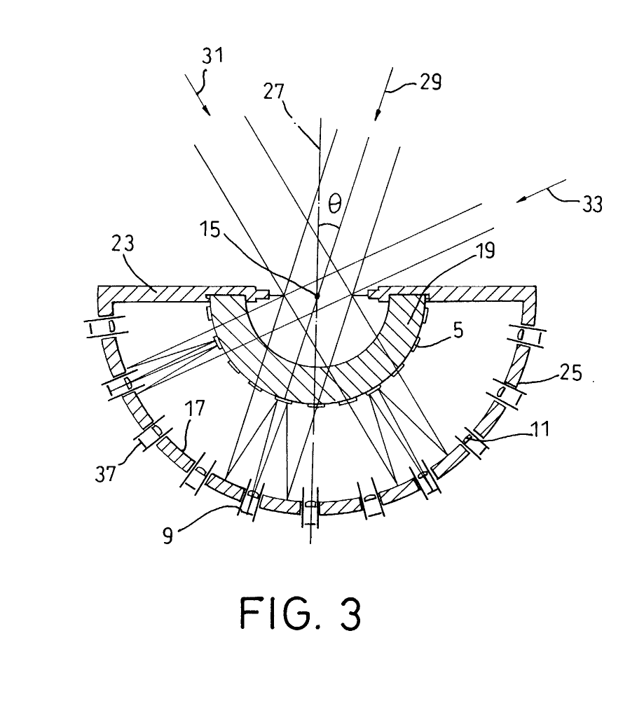

With reference to FIG. 3, light from any direction, such as a first light beam (29), a second light beam (31) and a third light beam (33) is refracted twice by the correction half-sphere lens (19), reflected by the primary half-sphere mirror (17) and re-reflected by the secondary mirror (5). The light then passes through the second correction lens (11) and an image is formed at a position (9) outside the primary half-sphere mirror (17).

If angle θ exists between the first light beam (29) and a central axis (27) of the primary half-sphere mirror (17) and an area of the shutter (21) is A. The projection of the shutter area A will become A cos θ. When θ=0°, the projection area of the shutter (21) is A. From experiments, it is noted that when θ=83°, A cos θ is approximately 10% of the result when θ=0°. Therefore, it is concluded that the image is bright in the central portion and dark in the edge portion.

Sensors (37) primarily sensing signals by 2-phase CCD are located at positions (9) to form images. Because the correction half-sphere lens (19) and the primary half-sphere mirror (17) are fixed with each other, the sensors (37) need to be adjusted to focus. After the installation of the sensors (37), the optical system of the present invention is somewhat like the compound eyes of a fly.

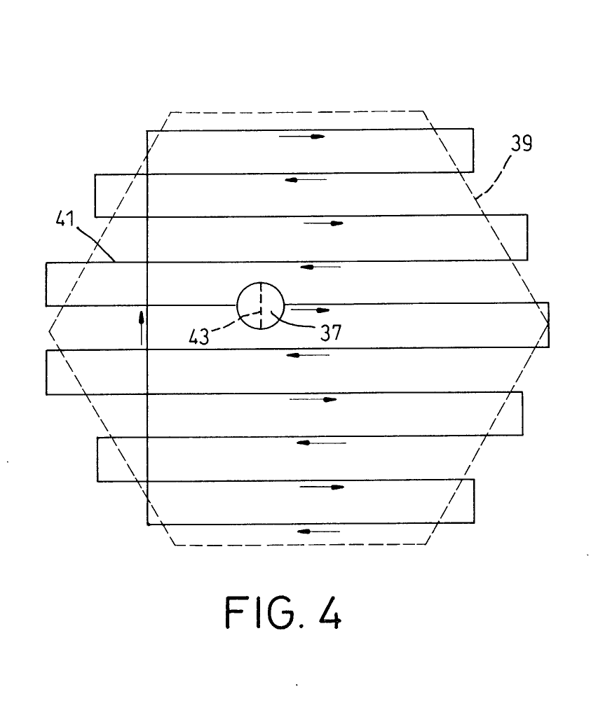

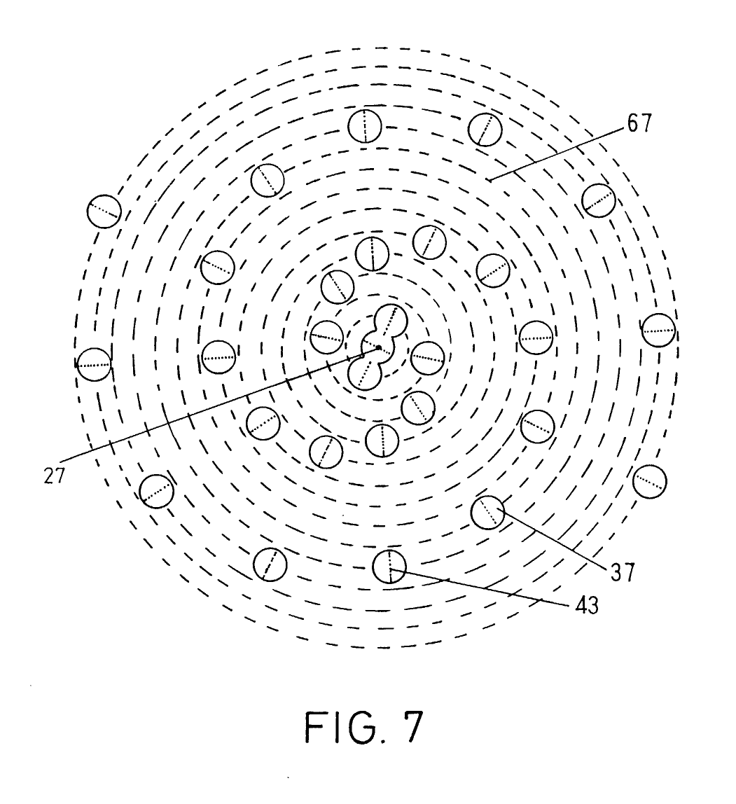

As described earlier, the optical system of the present invention is composed of multiple Maksukov Casegrain telescopes, however, each image formed is fixed and only part of an entire environment is scanned. A scanning process is required so as to scan through the entire area and combine all the partial images together. By means of the sensors (37), the change in the environment is observed. Also, with the assistance of image processing and storage techniques, small scanned areas are able to be combined into a large area. The sensors (37) may be changed to linear CCD or optical fibers (43). These kinds of linear elements have to be located vertical to the scanned direction, as shown in FIGS. 4 and 7. A general two-phase CCD has a resolution more than 500×500 pixels and a linear CCD has a resolution of more than 500 pixels.

In order to scan through the entire observed area, there are two different manners to drive the optical system to scan through the observed area, one is to swing and the other is to rotate.

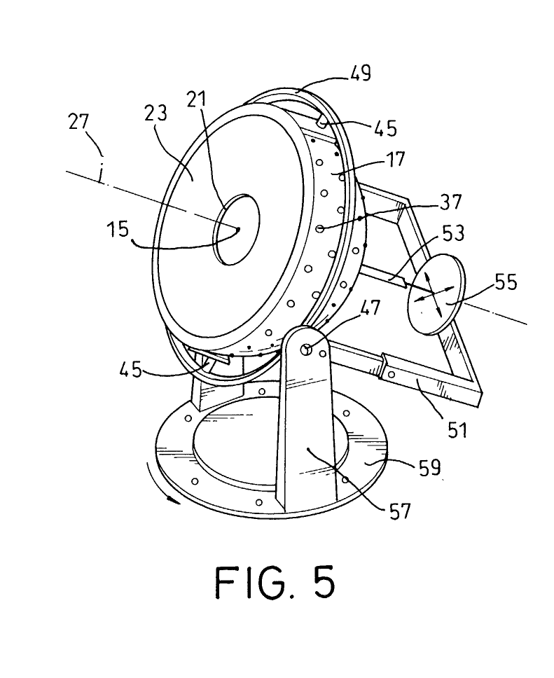

With reference to FIGS. 4 and 5, a support incorporated with the optical system of the present invention is shown. It is known that when the optical system of the present invention moves back and forth in a fixed pattern so as to cover a fixed area, such as the hexagon (39) shown in FIG. 4, because all the sensors (37) and the positions (9) are equally separated, the entire area in front of the optical system is able to be covered in a single scanning cycle.

Referring to FIG. 5, to accomplish the scanned area shown in FIG. 4, the support device has an x axis (45) passing through a ring (49) which is fixed to the cap (23) and a y axis (47) vertical to the x axis (45) and connected to two arms (57) which are located on a rotatable base (59). The base (59) is able to be firmly located on a wall, ceiling or any suitable surface so that after the support device is assembled, the working of the support device is somewhat like a gyroscope. A central axis (53) is connected to a platform (55) which is mounted on a U shaped frame (51) telescopic with respect to the central axis (53). Two distal ends of the U shaped frame (51) are connected to the respective ends of the y axis (47). After the support device is assembled, x-y directions are driven by two step motors (not shown) respectively to accomplish the scanned pattern.

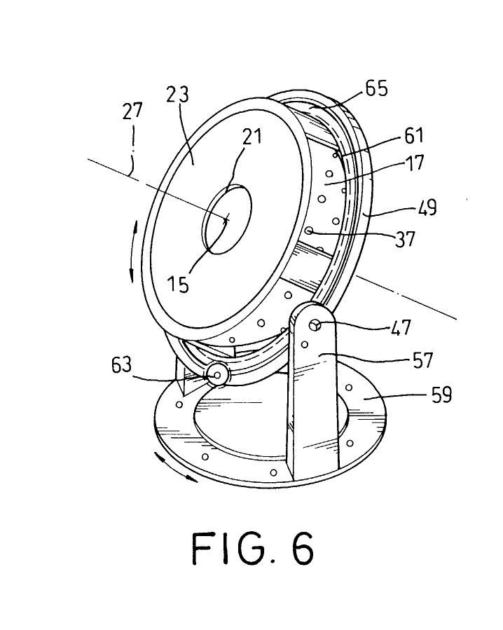

With reference to FIGS. 6 and 7, another support device is disclosed. The support device is to provide the optical system of the present invention a rotating scanned pattern as shown in FIG. 7. It is known from FIG. 7 that each of the sensors (37) is symmetrically located in each latitude of the half-sphere primary lens (17) relative to the central axis (27). However, if the sensors (37) are replaced by optical fibers (43), the optical fibers (43) should be located along each longitude of the half-sphere primary lens (17) so as to compensate the image while scanning. The support device has an annular gear (61) and a bearing (65) received in a ring (49). A y axis (47) passes through the ring (49) and connects two arms (57) which are both located on a rotatable base (59). A gear (63) driven by a step motor (not shown) is provided to mate the annular gear (61) so as to drive the optical system to rotate about the central axis (27).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical system comprising:
a correction half-sphere lens having multiple secondary mirrors mounted on an outer periphery of the correction half-sphere lens;
a primary half-sphere mirror coaxial and sharing a same curvature center with the correction half-sphere lens, the primary half-sphere mirror having multiple through holes each corresponding to one of the secondary mirrors and having a second correction lens received therein to receive light from the corresponding secondary mirror; and
a cap provided on top of the primary half-sphere mirror and having a shutter in a center of the cap to control incident light coming to the system.

2. The optical system as claimed in claim 1, wherein sensors are provided outside the primary half-sphere mirror to correspond to one of the second correction lens to form an image.

3. The optical system as claimed in claim 1 further comprising:
an x axis passing through a ring which is fixed to the cap to receive therein the primary half-sphere mirror;
a y axis perpendicular to the x axis and connected to two arms which are located on a rotatable base; and
a central axis connected to a platform which is mounted on a U shaped frame telescopic with respect to the central axis; wherein two distal ends of the U shaped frame are connected to respective ends of the y axis.

4. The optical system as claimed in claim 2 further comprising:
a ring provided to receive therein the primary half-sphere mirror;
an x axis passing through the ring which is fixed to the cap;
a y axis vertical to the x axis and connected to two arms which are located on a rotatable base; and
a central axis connected to a platform which is mounted on a U shaped frame telescopic with respect to the central axis; wherein two distal ends of the U shaped frame are connected to respective ends of the y axis.

5. The optical system as claimed in claim 1 further comprising:
an x axis passing through a ring which is fixed to the cap to receive therein the primary half-sphere mirror;
a y axis perpendicular to the x axis and connected to two arms which are located on a rotatable base;
an annular gear and a bearing received in the ring; and
a gear provided to mate the annular gear so as to drive the optical system to rotate.

6. The optical system as claimed in claim 2 further comprising:
an x axis passing through a ring which is fixed to the cap to receive therein the primary half-sphere mirror;
a y axis perpendicular to the x axis and connected to two arms which are located on a rotatable base;
an annular gear and a bearing received in the ring; and
a gear provided to mate the annular gear so as to drive the optical system to rotate.
